(19) United States
(12) Patent Application Publication
(10) Pub. No.: US 2010/0182771 A1
(43) Pub. Date: Jul. 22, 2010

(54) Ornamental container for containing refrangible/reflexible object

(75) Inventor: Chuan-Ying Chang, Taipei City (TW)

Correspondence Address: BACON & THOMAS, PLLC, 625 SLATERS LANE, FOURTH FLOOR, ALEXANDRIA, VA, 22314-1176, US

(73) Assignee: CALIBER MULTIMEDIA TECHNOLOGY & TRADING CO., LTD., Taoyuan County (TW)

(21) Appl. No.: 12/453,027

(22) Filed: Apr. 28, 2009

(30) Foreign Application Priority Data
Jan. 20, 2009 (TW) 98201095

(51) Int. Cl. F21V 33/00; B65D 85/00

(52) U.S. Cl. 362/155; 206/457

(57) ABSTRACT

An ornamental container includes a transparent bottle, a bottle cap, and an illuminating unit. The transparent bottle accommodates a refrangible/reflexible object. The bottle cap is formed of a hollow barrel and a cover member. The hollow barrel has a through hole running through a bottom side thereof. When the cover member is pressed, at least one part of the cover member is deformed or moved downwardly. The illuminating unit includes a power source, a circuit, a push switch, and a light source. The light generated by the light source passes through the through hole to be shone downwardly. The push switch is located below the cover member and can be forced by the downward deformation or movement of the cover member to activate or deactivate the light source. Therefore, the push switch is hidden to keep the delicacy of the ornamental container and the refrangible/reflexible object looks dazzling.

### BACKGROUND OF THE INVENTION

1. Field of the Invention

The present invention relates generally to ornaments, and more particularly, to an ornamental container containing a refrangible/reflexible object.

2. Description of the Related Art

A conventional ornament e.g. a transparent bottle, is usually contained with a doll, colored sands, or a miniature object, like sailboat, table, chair, plants, etc., for people's appreciation.

When an object, like glass or crystal, which can refract the light, or an object, like sequin or mirror, which can reflect the light is put into the transparent bottle, and then the light passes through the bottle, the light is reflected or refracted by the object in such a way that people feel dazzling while watching the bottle. Thus, the bottle has good ornamental effect.

Recently, some transparent bottles, each of which is provided with a light source shone on an object located therein to look dazzling on the whole, were presented. However, the light sources in some of them each may interference the object in location; the switches in some of them are located outside the bottle each to be inaesthetic.

### SUMMARY OF THE INVENTION

The primary objective of the present invention is to provide an ornamental container containing a refrangible/reflexible object, wherein the ornamental container avoids uglification.

The secondary objective of the present invention is to provide an ornamental container containing a refrangible/reflexible object, wherein the refrangible/reflexible object looks dazzling.

The foregoing objectives of the present invention are attained by the ornamental container composed of a transparent bottle, a bottle cap, and an illuminating unit. The transparent bottle having an opening formed at a top side thereof. A refrangible/reflexible object is put into the transparent bottle. The bottle cap is mounted to the top side of the transparent bottle to seal the opening. The illuminating unit includes a power source, a circuit, a push switch, and a light source. The power source can provide electric energy for the circuit. The push switch can be controlled to switch on or off the light source. The bottle cap is formed of a hollow barrel and a cover member. The hollow barrel has a through hole running through a bottom side thereof. The cover member is mounted onto the hollow barrel in such a way that a chamber is formed between the hollow barrel and the cover member. When the cover member is pressed by an external force, at least one part of the cover member is deformed or moved downward. The illuminating unit is mounted inside the chamber. The light generated by the light source passes through the through hole to be shone downwardly. The push switch is located below the cover member and can be forced by the downward deformation or movement of the cover member to activate or deactivate the light source. Therefore, the push switch is hidden in the bottle cap to keep the delicacy of the ornamental container and the refrangible/reflexible object inside the ornamental container looks dazzling.

### BRIEF DESCRIPTION OF THE DRAWINGS

FIG. 1 is a sectional view of a first preferred embodiment of the present invention, illustrating that the bottle cap is separated from the transparent bottle.

FIG. 2 is a sectional view of the first preferred embodiment of the present invention.

FIG. 3 is a perspective view of the bottle cap of a second preferred embodiment of the present invention.

FIG. 4 is a sectional view of the bottle cap of the second preferred embodiment of the present invention, illustrating that the barrel and the cover member are combined with each other.

### DETAILED DESCRIPTION OF PREFERRED EMBODIMENTS

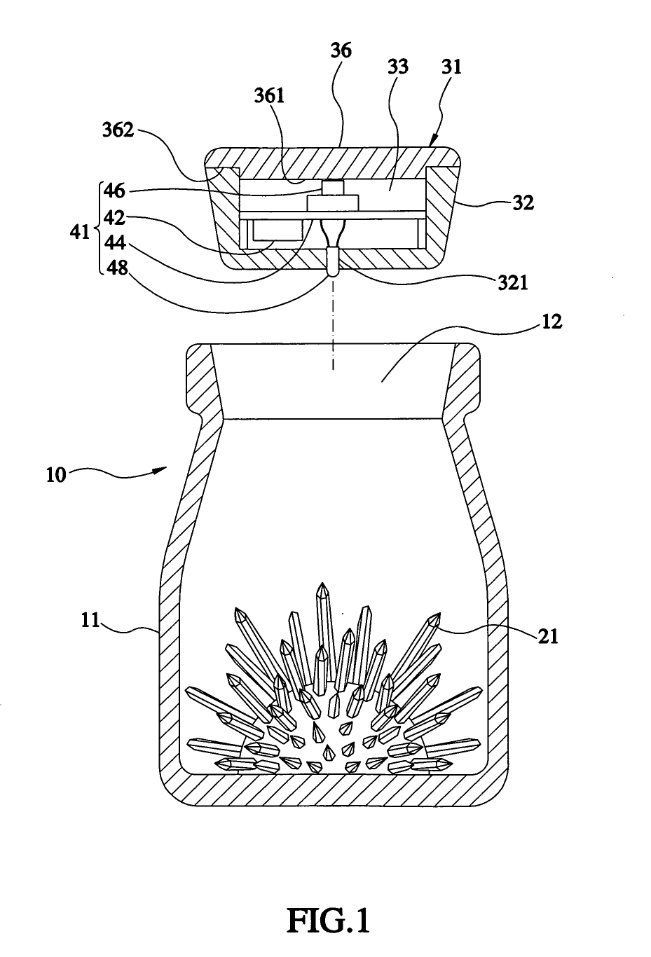

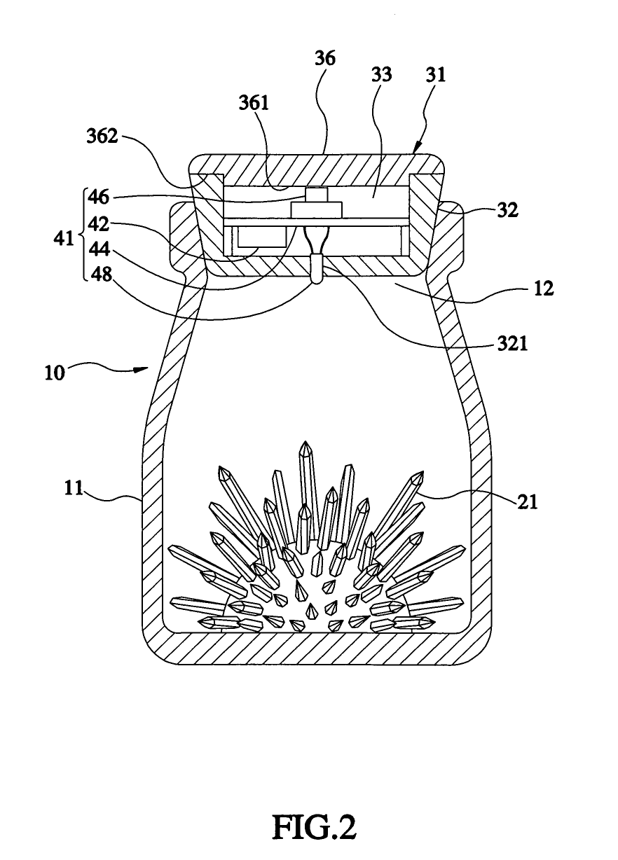

Referring to FIGS. 1-2, an ornamental container 10 constructed according to a first preferred embodiment of the present invention is composed of a transparent bottle 11, a bottle cap 31, and an illuminating unit 41.

The transparent bottle 11 includes an opening 12 formed on a top side thereof, for accommodating a refrangible/reflexible object 21. The refrangible/reflexible object 21 is a crystal, crystallization, glass, sequin, or lens, and put inside the transparent container 11.

The bottle cap 31 is mounted to the opening 12.

The illuminating unit 41 includes a power source 42, a circuit 44, a push switch 46, and a light source 48. The power source 42 can provide electric energy for the circuit 44. The light source 48 can be controlled by the push switch 46 for activation or deactivation. In this embodiment of the present invention, the power source is a battery and the light source is a light emitting diode (LED), which can be controlled by the circuit 44 to change the color of its light. Because the circuit controlling illumination of the LED belongs to the prior art to be insignificant for the present invention, no more recitation in this regard will be necessary.

The bottle cap 31 is formed of a hollow barrel 32 and a cover member 36. The barrel 32 includes a through hole 321 running through a bottom side thereof. The cover member 36 is mounted onto the hollow barrel 32 in such a way that a chamber 33 is formed between the hollow barrel 32 and the cover member 36. The cover member 36 is a cork in this embodiment, having a convex portion 361 and a stepped portion 362. The convex portion 361 extends downward from a bottom side of the cover member 36 into an end edge of an opening of the hollow barrel 32. The stepped portion 362 is formed at a peripheral edge of the convex portion 361 and stopped against the end edge of the opening of the hollow barrel 32. When the cover member 36 is pushed by an external force, a part of the cover member 36 is deformed downward.

The illuminating unit 41 is received in the chamber 33. The light source 48 is put into the through hole 321, having a part passing downwardly through the through hole 321 and then exposed outside the hollow barrel 32. The light generated by the light source 48 is shone downwardly. The push switch 46 is located below the cover member 36 and can be forced by the downward deformation of the cover member 36 to activate or deactivate the light source.

Referring to FIG. 2, when a user presses the cover member 36, the cover member 36 is deformed downwardly to work on the push switch 46 to enable the push switch 46 to switch on the light source 48 for illumination on the object 21. The object 21 shown in FIG. 2 is crystallization. Because the object 21 can refract the light, the user feels dazzling while seeing multiple refractions of the light. If it is intended to switch off the light source 48, the user can press the cover 36 again to do the job.

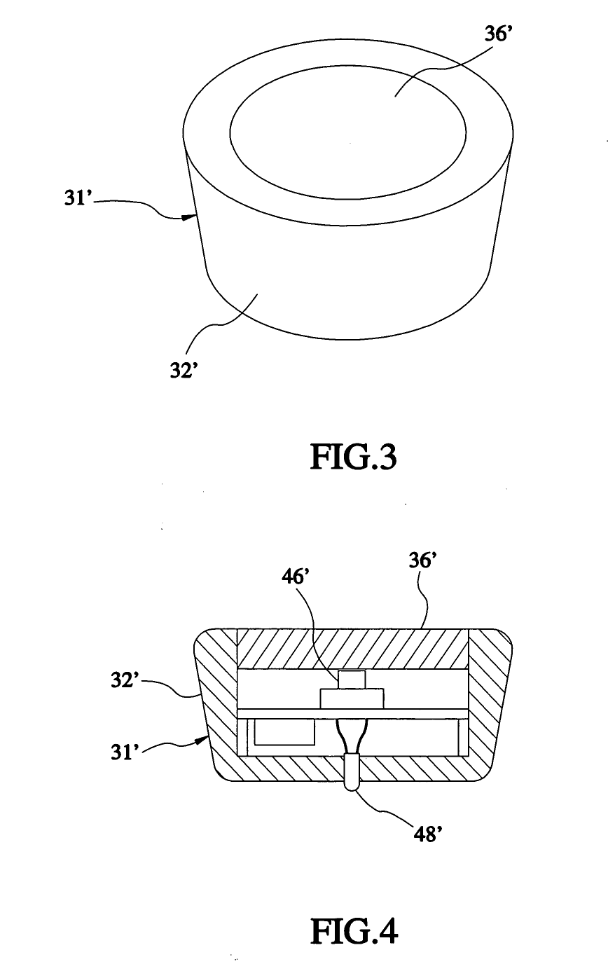

Referring to FIGS. 3-4, an ornamental container constructed according to a second preferred embodiment of the present invention is similar to that of the first embodiment, having the following difference. The cover member 36′ of the bottle cap 31′ of the second embodiment is tightly stopped at an internal sidewall of the opening of the hollow barrel 32′. When the cover member 36′ is pressed by an external force, the whole cover member 36′ is moved downwardly to work on the push switch 46′. While operating the ornamental container of the second embodiment, likewise, the user can press the cover member 36′ to force the cover member 36′ to move downwardly and then the cover member 36′ works on the push switch 46′ to switch on or off the light source 48′, thus reaching the same effect as the first embodiment does.

In conclusion, the present invention includes the following effects.

1. The push switch is hidden in the bottle cap and the cover member can be pressed for downward deformation or movement to work on the push switch, such that the present invention is not only aesthetic in appearance but still operable for the user.

2. When the light source is activated, the light is shone on the object and then refracted or reflected to enable the object to look dazzling. On the whole, the present invention has good ornamental effect.

Although the present invention has been described with respect to specific preferred embodiments thereof, it is no way limited to the details of the illustrated structures but changes and modifications may be made within the scope of the appended claims.

What is claimed is:

1. An ornamental container having a refrangible/reflexible object, comprising:
a transparent container having an opening formed at a top side thereof, accommodating a refrangible/reflexible object;
a bottle cap mounted to said opening and having a hollow barrel and a cover member, said hollow barrel having a through hole running through a bottom side thereof, said cover member being mounted onto said hollow barrel, whereby a chamber is formed between said cover member and said hollow barrel, and at least one part of said cover member is deformed or moved downwardly while the cover member is pressed; and
an illuminating unit received in said chamber and having a power source, a circuit, a push switch, and a light source, said power source providing electric energy for said circuit, the light generated by said light source being shone downwardly through said through hole, said push switch being located below said cover member and switchable by the downward deformation or movement of said cover member to activate or deactivate said light source.

2. The ornamental container as defined in claim 1, wherein said cover member comprises a convex portion extending downwardly from a bottom side thereof, and a stepped portion formed at a peripheral edge thereof and stopped at an end edge of an opening of said hollow barrel.

3. The ornamental container as defined in claim 1, wherein said cover member is tightly stopped at an internal sidewall of the opening of said hollow barrel.

4. The ornamental container as defined in claim 1, wherein said power source is a battery.

5. The ornamental container as defined in claim 1, wherein said light source is an LED.

6. The ornamental container as defined in claim 1, wherein the light of said light source is variable in color.

7. The ornamental container as defined in claim 1, wherein said light source is put into said through hole and comprises a part passing downwardly through said through hole and then exposed outside said hollow barrel.
